(19) United States
(12) Patent Application Publication
(10) Pub. No.: US 2008/0016219 A1
(43) Pub. Date: Jan. 17, 2008

(54) Conditional URL For Computer Devices

(75) Inventors: Michael Libes, Bainbridge Island, WA (US); Eric Fu, Bellevue, WA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Medio Systems, Inc., Seattle, WA (US)

(21) Appl. No.: 11/776,080

(22) Filed: Jul. 11, 2007

Related U.S. Application Data
(60) Provisional application No. 60/807,606, filed on Jul. 17, 2006.

(51) Int. Cl. G06F 15/173

(52) U.S. Cl. 709/226

(57) ABSTRACT

A resource request is received at a computer application, wherein the resource request has a resource specification that determines multiple resources for fulfillment. The received resource specification is evaluated, a plurality of computer resources are identified for processing of the resource request in accordance with the evaluated resource specification, and an order of processing the request among the identified computer resources is identified for fulfillment of the resource request. The resource request itself can determine network locations at which the requested resource can be found. In the case of a Web browser user application that is configured to process such a conditional resource request, the request comprises a conditional uniform resource locator (C-URL) that describes one or more network locations at which a single resource may be accessed.

### CROSS-REFERENCE TO RELATED APPLICATION

This application claims the benefit of U.S. Provisional Application No. 60/807,606 filed Jul. 17, 2006 entitled Conditional URL for Computer Devices to Michael Libes and Eric Fu. The disclosure of the Provisional Application No. 60/807,606 is incorporated herein by reference in its entirety for all purposes.

This application claims the benefit of priority of co-pending U.S. Provisional patent Application Ser. No. 60/807,606 entitled “Conditional URL For Computer Devices” filed Jul. 17, 2006. Priority of the filing date of Jul. 17, 2006 is hereby claimed, and the disclosure of the Provisional Patent Application is hereby incorporated by reference.

### BACKGROUND

As computer devices are operated, there are circumstances under which available resources must be located. For example, in navigating the Internet, the Uniform Resource Locator (URL) is a means of specifying the location of network resources and is a key component in making the Internet easy to use. Billions of people are familiar with URLs beginning with “http://www” and recognize them as indicating addresses (locations) on the World Wide Web. These people have experience with using a computer device and gaining access to Web pages through an Internet browser application.

In this way, a URL acts as a request for service from a specified network resource. The request is initiated by a computer device that is connected to the network and that therefore is, itself, a node of the network. For example, a URL beginning with the characters “http://www” and ending with the characters “.html” can be provided to an Internet browser and will be recognized as specifying a Web page, which the browser will retrieve from the URL address and render for display to the user. In that scenario, the “html” URL requests a Web page (the service) from a Web server (the resource), which is received by the browser and is processed (i.e., rendered).

Service from other resources comprising different applications can be requested. For example, a browser that is provided with a URL beginning with “http://www” and ending with “.pdf” will recognize the URL as calling for a file on the World Wide Web that should be rendered according to the “PDF” file format as specified by Adobe Systems Incorporated of San Jose, Calif., USA. The browser can automatically launch an appropriate application to open the PDF file and display it properly. Other file extensions can be recognized as being associated with other programs, which the browser can look for on the host computer.

Other formats of URLs can act as requests for service from a corresponding resource of a different type. A URL beginning with “mailto:” and appended with an email address (e.g. name@place.com) can cause the browser to automatically launch an email application that sets up a message that is directed to the appended email address. In this scenario, the “mailto:” URL can be viewed as requesting an email message service from an email application resource. The email application makes use of network communications and is characterized as a network resource, even though the email application itself may be locally installed on the computer device. Other URL formats request other types of resources that can be accessed over the Internet. For example, URLs beginning with “ftp:” and “tel:” provide integration with additional services for file servers (ftp) and telephone connections (tel). Other URL formats can request other computer resources, such as search engines, printing services, multimedia presentations, and the like.

The core concepts behind successful utilization of Internet URLs for resource requests are that (a) each resource is assigned a unique network location, specified by a URL, and (b) it is assumed that all resources specified by a URL are accessible by any computer connected to the network. Thus, a URL specifies a network address at which communications occur between a requesting network node (the user device) and a specified resource.

These assumption do not necessarily hold true for mobile and wireless devices which may be only occasionally connected to the network. Most Internet resources, such as Web servers, file servers, and email servers, are continuously available to receive service requests. But when mobile and wireless devices are not connected to the network, they cannot submit network service requests and cannot be reached via any URL at which they would otherwise be communicating. Additionally, there are occasions on non-mobile computers where URLs, as defined today, are insufficient to easily locate a resource.

In addition to Internet browsers, other applications on computer devices may be configured to locate resources (such as files or applications) in response to receiving resource parameters (e.g. file identifiers or application names). For example, file finder or explorer applications can be used to search for resources such as data files or installed applications. Typically, such resource finding applications are limited in the resources and domains over which they will search, such as being limited to searching only a local hard disk drive or a particular network store for a specified item. Thus, the range of resources over which searching can occur is limited.

Locating resources on network-capable mobile devices such as cell telephones and Personal Digital Assistants (PDAs) can be especially troublesome because of the typically limited application catalog available on such devices. For more powerful computer systems such as desktop computers and laptop computers, a program and/or resource registry determines the resources available to applications. If an application on a computer system requests processing from a resource comprising a second application, the first application can determine whether the second application is installed by consulting the registry and, if the second application is missing, it can request network access (such as by launching a Web browser) to retrieve and download the second application. Mobile devices, in contrast, typically have relatively simple application catalogs and do not have the more sophisticated resource registries and operating capabilities to identify missing applications and request their download and installation. Thus, resource requests on mobile devices are more likely to fail in the case of missing applications.

It should be apparent that the computer resource search and location experience would be improved if the resources and network conditions over which search is performed could be enlarged. The present invention satisfies this need.

### SUMMARY

In accordance with the invention, a resource request is received at a computer application, wherein the resource request has a resource specification that determines multiple resources for fulfillment. The received resource specification is evaluated, a plurality of computer resources are identified for processing of the resource request in accordance with the evaluated resource specification, and an order of processing the request among the identified resources is identified for fulfillment of the resource request. Thus, multiple resources can be determined from a single resource request and the multiple resources can be utilized for fulfillment of the request. If desired, the computer application can be installed at a computer device that communicates with a network, so that resources available to the computer application can include network resources. The resource request itself can determine network locations at which the requested resource can be found. With this technique, it is not necessary for the computer application to have access to a resource registry to locate resources or to communicate with other applications, rather, the conditional resource request is self-contained. In the case of a Web browser application that is configured to process such a conditional resource request, the request comprises a conditional uniform resource locator (C-URL) that describes one or more network locations at which a single resource may be accessed.

The resource request can determine multiple resources in a variety of ways. The request, for example, can comprise an implicit conditional Boolean statement or an explicit conditional Boolean statement that can be evaluated to determine resource locations and processing to gain access for fulfillment of the resource request. The schema for composing a conditional resource request can include a parameter set that is used in the evaluation of the statement and in the processing of the request. The resources being located can include network computers, files, devices, servers, Web pages, messages, and the like.

Other features and advantages of the present invention should be apparent from the following description of the preferred embodiments, which illustrate, by way of example, the principles of the invention.

### BRIEF DESCRIPTION OF THE DRAWINGS

FIG. 1 is a block diagram of a system that implements an embodiment of the present invention.

FIG. 2 depicts a URL schema that is received and processed by the system illustrated in FIG. 1.

FIG. 3 is a flow diagram of operations performed by the FIG. 1 system in fulfilling a conditional resource request.

FIG. 4 depicts an implicit conditional resource request that is received and processed by the system illustrated in FIG. 1.

FIG. 5 is a flow diagram of operations performed by the FIG. 1 system in fulfilling an implicit conditional resource request.

FIG. 6 depicts an explicit conditional resource request that is received and processed by the system illustrated in FIG. 1.

FIG. 7 is a flow diagram of operations performed by the FIG. 1 system in fulfilling an explicit conditional resource request.

FIG. 8 depicts an explicit conditional resource request containing a multiple Boolean expression that can be received and processed by the FIG. 1 system.

FIG. 9 is a flow diagram of operations performed by the FIG. 1 system in fulfilling a multiple Boolean conditional resource request.

### DETAILED DESCRIPTION

A conditional resource request for computer services can specify more than one pathway for fulfillment of the resource request. The specified conditions and pathways can include multiple computer resources and network conditions. In this way, the integration and user experience in accessing multiple software applications on mobile devices is improved. One application of the conditional resource request is the specification for a resource that will be accessed over the Internet, as conventionally specified in a Uniform Resource Locator (URL) address. When an embodiment of the present invention is used to fulfill such a conditional resource request, the request provides what can be characterized as a conditional URL. In this discussion, a conditional resource request for processing in accordance with the invention will be generally referred to as a “conditional URL”, whether or not the requested resource is a Web page. That is, it should be understood that a “conditional URL” in this context will be applied to a conditional resource request regardless of the nature of the requested resource.

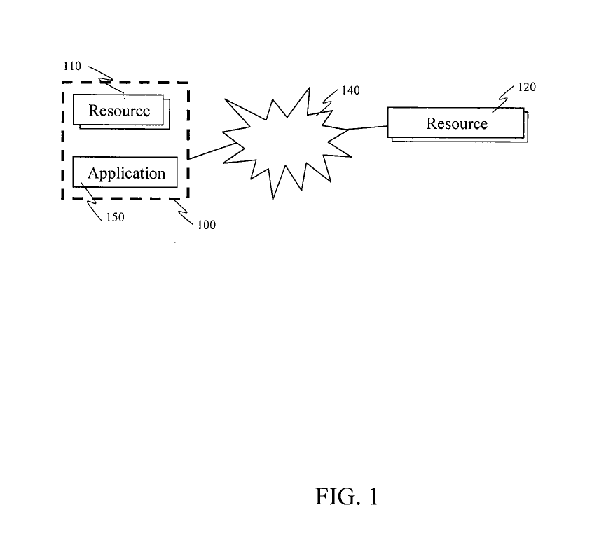

An example of a system that provides the conditional URL (C-URL) features described herein is illustrated in FIG. 1, which shows that the system includes a computer device 100, one or more resources 110 and 120, an application 150 at the computer that contains the logic to gather data from available resources and process the C-URL, and a wireless or wireline network 140 over which the computer can communicate with the resources 110, 120. A user at the computer 100 can submit conditional resource requests for service in accordance with conditional processing by the conditional-configured application 150. The resource requests can be submitted by, for example, using a typical browser in a graphical user interface and typing a C-URL in the address window of the browser. The browser application then processes the request after the user presses “enter” or otherwise initiates processing of the browser address window contents.

FIG. 1 shows that the first resource 110 is available or installed at the computer device 100. The computer device includes a processor and an operating system with which available resources can be determined by the application 150. The computer device 100 can comprise, for example, a mobile telephone, a PDA, a desktop computer, or a laptop computer. FIG. 1 shows that the second resource 120 is available to the computer application 150 over the network 140. The resources 110, 120 can comprise any resources providing services that might be requested by the computer application 150, including resources such as software applications, hardware devices, or servers, combinations of such, and the like. For example, the resource 120 can comprise a catalog for a collection of applications that can be downloaded and installed by the computer application 150.

In FIG. 1, the computer application 150 receives a conditional resource request for access to one or more resources, wherein the request includes a C-URL that identifies at least one network location for the requested resource. The computer application can comprise, for example, a C-URL-enabled mobile device browser or a device file finder or explorer application, or the application can comprise a mail program or an Internet browser or other C-URL-enabled application that interfaces to the C-URL browser or the device finder/explorer application. In either case, the C-URL-enabled application 150 does not simply parse the C-URL resource request and directly access the location determined from the request. Instead, the logic in the application 150 performs a computation to evaluate a conditional statement determined from the request, and uses that evaluation to determine which of the locations or resources specified within the C-URL to use. This conditional statement can be specified implicitly within the C-URL schema, or explicitly as an arithmetic or Boolean expression to be evaluated.

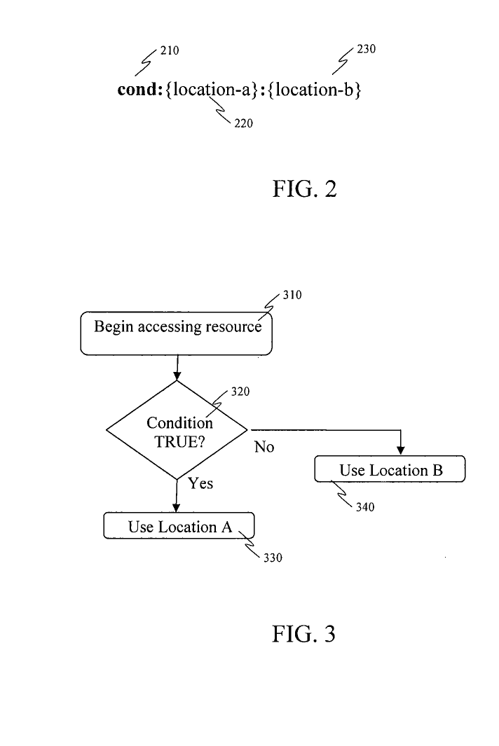

FIG. 2 shows a URL schema specifying an implicit conditional URL in a generalized form for processing by the FIG. 1 application 150. The URL schema shown in FIG. 2 includes a conditional statement identifier 210 that informs the application 150 what conditional test to perform. In FIG. 2 the conditional identifier is illustrated as the text string “cond”. The remainder of the C-URL specifies two resources that are the object of the request, a resource specified as location-a 220 and a resource specified as location-b 230, which will be used by the application 150 in response to the outcome of the conditional statement 210 to determine which resource 220, 230 to access.

FIG. 3 is a flow diagram that shows the generalized sequence of operations performed by the system of FIG. 1 for accessing resources specified via the C-URL. The operations begin at box 310 of FIG. 3, where the resource request is received at the application 150 (FIG. 1), such as a C-URL-enabled Web browser. The “Begin accessing resource” operation of box 310 represents processing that includes parsing of the received C-URL, determining the C-URL schema and its parameters, and identifying and accessing the resources identified by the C-URL. At box 320, the evaluation of the conditional statement or specification of the C-URL schema 210 is performed. If the condition is true, then at box 330 the application uses the first resource 220, and otherwise at box 340 the application uses the second resource 230 to fulfill the resource request. Computer operation then continues. In the context of this description, “fulfillment” of the resource request comprises compliance with or satisfactory completion of a task or service that is the object of the resource request. For example, a resource request comprising a request for a Web page is fulfilled by return of the page, a request for file transfer (FTP) is fulfilled by return of the file, and request for access to a device such as a peripheral device or a server is fulfilled by return authorization that enables such access.

Both resources 220, 230 specified in the request can be located at the user device 100 where the application 150 is installed, or both resources may be accessed over the network 140, or the resources can be at different locations. That is, one of the specified resources 220, 230 can be at the computer device 100 of the user and the other resource can be at a different network location, or both resources 220, 230 can be at the computer device, or both resources can be at network locations (at either the same network location or at different network locations). A requested application or other resource that is installed at the same computer device as the user application 150 will be referred to as a requested application that is “native” to the user application.

Those skilled in the art will understand that the C-URL can be specified via a variety of syntax, and will understand that the conditional statement or operation can relate to more than two states, matching to more than two resource locations. An example of such multiple state, multiple location requests will be described further below.

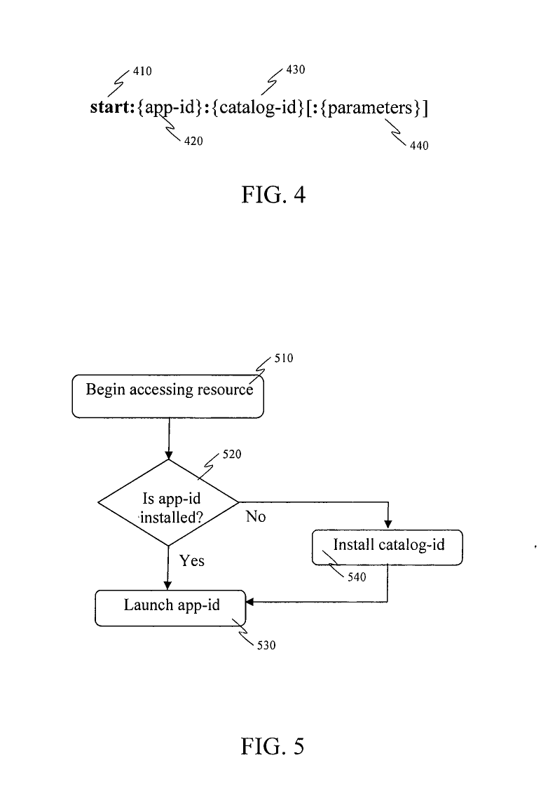

FIG. 4 shows an example of an implicit C-URL for processing by the system illustrated in FIG. 1. The implicit C-URL of FIG. 4 includes a schema identifier 410, an application or resource identifier 420, a catalog identifier 430, and a parameter set 440 that is optional (as indicated by the brackets [ ] in FIG. 4). The C-URL shown in FIG. 4 can be used to launch an application, determined from the identifier 420, but it should be understood that the C-URL could also be used for other actions as well, such as to gain access to other resources, to other applications, or computers, and the like.

The FIG. 4 C-URL includes a schema 410 comprising a text string “start” that informs the computer application to look up the application or resource specified from the application identifier given by “app-id” 420 from among the applications or resources identified on the device at which the user application is installed, or available to the device. The components of the FIG. 4 schema are delimited by colons (“:”) that are used by the user application in parsing the C-URL string.

FIG. 5 is a flow diagram that illustrates the flow of operations by the FIG. 1 system for implementing the FIG. 4 schema. The computer application 150 (FIG. 1) will respond to a conditional resource request by parsing the request, identifying the schema and its parameters, and beginning access operations by examining the computer device 100 and attempting to locate the proper application or resource on the computer device. This operation is illustrated as box 510 in FIG. 5. The application 150 checks to determine if the requested application or resource is installed on the computer device 100 (indicated at box 520). If the application is installed locally or if the resource is otherwise available (a “YES” outcome at box 520), then it is launched and the optional parameters 440 are passed along to the identified application or resource (indicated at box 530), and operation continues. If the requested application or resource is not available (a “NO” outcome at box 520), then at box 540 the location specified by the catalog identifier 430 is used to retrieve and install the application (resource), after which the installed application is launched with the optional parameters 440 passed along for operation (as indicated at box 530).

For example, if a Web browser request is for a page or file that is formatted in a non-html format, such as the Portable Document Format (PDF) specification of Adobe Systems Incorporated, then the C-URL enabled browser 150 will examine the computer device 100 to determine if a native PDF-processing application is available. If the application is available, it will be used to open and/or render the file that is the object of the resource request. If no such application is available locally at the device, then the browser 150 will consult the catalog-id 430, retrieve the appropriate application, install the application, and then launch the application to open and/or render the requested file.

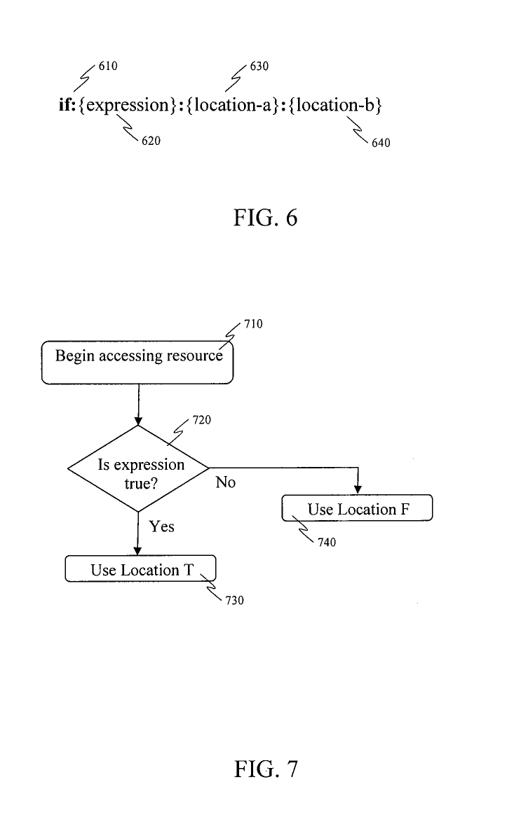

FIG. 6 shows the general syntax of an explicit C-URL. The C-URL of FIG. 6 includes a schema identifier 610, a logic statement or expression 620, a first location identifier 630, and a second location identifier 640. FIG. 7 shows the flow of operations for implementing the FIG. 6 schema. The schema identifier of FIG. 6 shows it is an “if” schema, which informs the application 150 to evaluate the expression specified in the expression portion 620 of the C-URL. The application, properly configured to implement the C-URL, will parse the C-URL, identify the schema and its parameters, and evaluate the expression contained in the C-URL. This evaluation operation is represented by box 710 in FIG. 7. The expression 620 can be a Boolean expression accessing variables local to the application, comparing capabilities of the device running the application, or itself can be a URL referencing a Boolean value. The expression 620 is evaluated to determine if it has a logic value of “True” or “False”, or other predetermined values. This operation is represented at box 720. If the expression 620 has a “true” condition (a “Yes” outcome at box 720), then the first location 630 is used to access the resource (box 730) and operation continues. If the expression is a “false” condition (a “No” outcome at box 720), then the second location 640 is used to access the resource (box 740) and operation continues.

An example of an explicit C-URL that might be especially useful to a wireless device application configured in accordance with the invention is given by the text string “if:width%3E240:/240/icon:/96/icon”. Those skilled in the art will recognize that the text string “%3E” represents a URL encoding that is processed by the computer application, such as a wireless browser, to be recognized as “>” (greater than). This explicit C-URL specifies two sizes of icon depending on the width of the device display area. That is, “if” specifies the explicit C-URL, “width%3E” specifies a conditional expression for width >240, and the size of icon if the expression is true (location-a of the schema) is specified as 240 and the size of icon otherwise (location-b of the schema) is specified as 96.

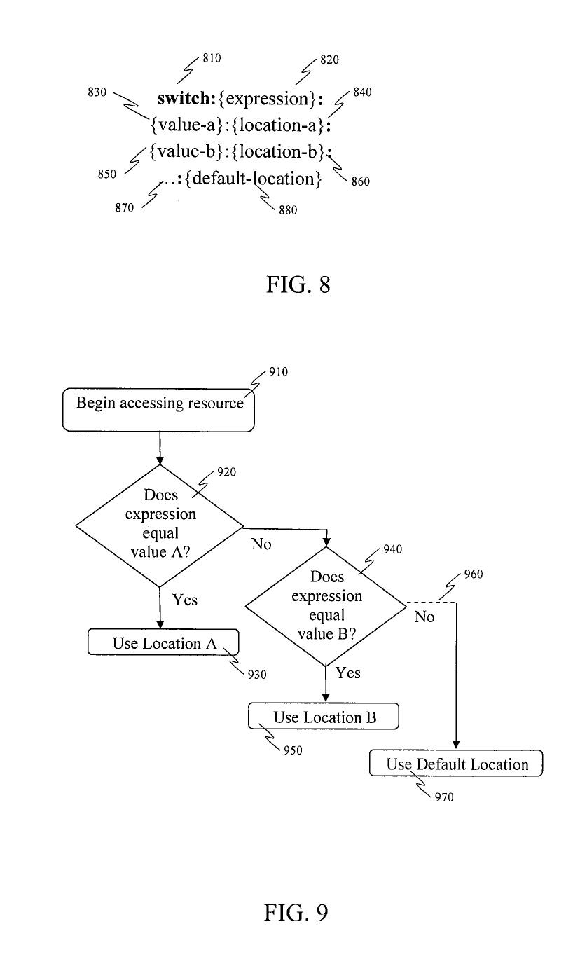

FIG. 8 shows the general syntax of an explicit conditional URL which allows for matching arbitrary values of more than one expression. The flow of operations for this schema is shown in FIG. 9. The application evaluates the C-URL and identifies the “switch” schema 810, which informs the application 150 to compute the expression specified in part 820 of the URL (box 910). The expression can access variables local to the application, comparing capabilities of the device running the application, or itself a URL referencing an arbitrary value. If the expression is equal to the value specified in part 830 of the URL (box 920), the location specified in part 840 is used to access the resource (box 930). If the expression is equal to the value specified in part 850 of the URL (box 940), the location specified in part 860 is used to access the resource (box 950). This continues for as many value:location pairs as are present in the C-URL (shown as the 870 ellipsis in the syntax and 960 dotted line in the flow diagram). If none of the values match, the 880 default location is used to access the resource (box 970).

An example of this explicit C-URL that might be especially useful to a wireless application is given by: “switch:width:96:96/icon:120:120/icon:240:240/icon:/64/icon”.

This C-URL specifies four sizes of icon depending on the width of the display area, with a default value in the case where none of the sizes match. In particular, if the display width (expression) is “96” (value-a), then the C-URL-enabled application uses “96/icon”, if the display width is “120” then the application uses “120/icon”, if the display width is “240” then the “240/icon” is used, and the default (if width is not 96, or 120, or 240) is to use “64/icon”. The “expression” need not be numeric. For example, the expression can be alphabetic text such as the C-URL given by “switch:name:bob:bob.html:mary:mary.html:default.html”. In this last example, if the “name” is “bob”, then the Web page “bob.html” is used, if the “name” is “mary” then the Web page “mary.html” is used, and if name is neither “bob” nor “mary” then the Web page “default.html” is used.

Having fully described several embodiments of the present invention, other equivalent or alternative methods of practicing the present invention will be apparent to those skilled in the art. These and other embodiments as well as alternatives and equivalents to the described system will be recognizable to those of skill in the art after reading the description herein. The scope of the invention should not, therefore, be determined solely by reference to the above description, but instead should be determined with reference to the appended claims along with their full scope of equivalents and alternatives.

We claim:

1. A computer method of processing a resource request, the method comprising:
receiving a resource request at a computer application, the resource request having a resource specification;
evaluating the resource specification;
identifying a plurality of computer resources for processing of the resource request in accordance with the evaluated resource specification and determining an order of processing the request among the identified computer resources for fulfillment of the resource request.

2. The method as defined in claim 1, wherein the resource specification comprises a conditional statement whose evaluation determines the order of processing the resource request.

3. The method as defined in claim 2, wherein the resource specification comprises an implicit conditional statement.

4. The method as defined in claim 3, wherein the resource specification includes a schema identifier, a resource identifier, and a parameter set.

5. The method as defined in claim 4, wherein the resource specification further includes a catalog identifier.

6. The method as defined in claim 1, wherein the computer application is installed at a network location and at least one of the computer resources is at a network location other than the computer application.

7. The method as defined in claim 1, wherein the computer application is installed at a network location and at least one of the computer resources is located at the network location of the computer application.

8. The method as defined in claim 1, wherein the order of processing determines a sequence of the identified computer resources with which the resource request will be processed until the request is fulfilled.

9. The method as defined in claim 1, wherein the order of processing determines a sequence of the identified computer resources with which the resource request will be processed until all the identified computer resources have processed the request.

10. The method as defined in claim 1, wherein the resource request comprises a request for a document.

11. The method as defined in claim 10, wherein the computer application comprises a browser that can render markup language pages and the requested document comprises a markup language page at one or more network locations specified by the resource request.

12. The method as defined in claim 11, wherein the browser attempts to retrieve the markup language page from each of the network locations specified by the resource request until the browser successfully renders the markup language page.

13. The method as defined in claim 1, wherein the resource request comprises a request for access to a computer software program.

14. The method as defined in claim 13, wherein the resource specification identifies a network location at which the computer software program can be found if the computer software program is not a native application to the computer application.

15. The method as defined in claim 14, wherein the computer application initiates installation of the computer software program so that it thereafter is a native application to the computer application.

16. A computer device for processing a resource request, the computer device comprising:
input means for receiving a resource request having a resource specification;
a request processor that evaluates the resource specification and identifies a plurality of computer resources for processing of the resource request in accordance with the evaluated resource specification and determining an order of processing the request among the identified computer resources for fulfillment of the resource request.

17. The computer device as defined in claim 16, wherein the resource specification comprises a conditional statement whose evaluation determines the order of processing the resource request.

18. The computer device as defined in claim 15, wherein the resource specification comprises an implicit conditional statement.

19. The computer device as defined in claim 18, wherein the resource specification includes a schema identifier, a resource identifier, and a parameter set.

20. The computer device as defined in claim 19, wherein the resource specification further includes a catalog identifier.

21. The computer device as defined in claim 16, wherein the request processor comprises a computer application that is installed at a network location and at least one of the computer resources is at a network location other than the computer application.

22. The computer device as defined in claim 16, wherein the request processor comprises a computer application that is installed at a network location and at least one of the computer resources is located at the network location of the computer application.

23. The computer device as defined in claim 16, wherein the order of processing determines a sequence of the identified computer resources with which the resource request will be processed until the request is fulfilled.

24. The computer device as defined in claim 16, wherein the order of processing determines a sequence of the identified computer resources with which the resource request will be processed until all the identified computer resources have processed the request.

25. The computer device as defined in claim 16, wherein the resource request comprises a request for a document.

26. The computer device as defined in claim 25, wherein the request processor comprises a browser computer application that can render markup language pages and the requested document comprises a markup language page at one or more network locations specified by the resource request.

27. The computer device as defined in claim 26, wherein the browser computer application attempts to retrieve the markup language page from each of the network locations specified by the resource request until the browser computer application successfully renders the markup language page.

28. The computer device as defined in claim 16, wherein the resource request comprises a request for access to a computer software program.

29. The computer device as defined in claim 28, wherein the resource specification identifies a network location at which the computer software program can be found if the computer software program is not a native application to the computer application.

30. The computer device as defined in claim 29, wherein the request processor comprises a computer application that initiates installation of the computer software program so that it thereafter is a native application to the computer application.
